(19) United States
(12) Patent Application Publication
(10) Pub. No.: US 2010/0104018 A1
(43) Pub. Date: Apr. 29, 2010

(54) SYSTEM, METHOD AND COMPUTER-ACCESSIBLE MEDIUM FOR PROVIDING BODY SIGNATURE RECOGNITION

(75) Inventors: Christoph Bregler, New York, NY (US); Cuong George Williams, Las Vegas, NV (US); Ian McDowall, Woodside, CA (US); Sally Rosenthal, Palo Alto, CA (US)

Correspondence Address: DORSEY & WHITNEY LLP;INTELLECTUAL PROPERTY DEPARTMENT, 250 PARK AVENUE, NEW YORK, NY, 10177, US

(73) Assignee: New York University, New York, NY (US)

(21) Appl. No.: 12/539,306

(22) Filed: Aug. 11, 2009

Related U.S. Application Data
(60) Provisional application No. 61/087,880, filed on Aug. 11, 2008.

(51) Int. Cl. H04N 11/02

(52) U.S. Cl. 375/240.16; 375/E07.001

(57) ABSTRACT

Provided and described herein are, e.g., exemplary embodiments of systems, methods, procedures, devices, computer-accessible media, computing arrangements and processing arrangements in accordance with the present disclosure related to body signature recognition and acoustic speaker verification utilizing body language features. For example, certain exemplary embodiments can include a computer-accessible medium containing executable instructions thereon. When one or more computing arrangements executes the instructions, the computing arrangement(s) can be configured to perform certain exemplary procedures, including (i) receiving first information relating to one or more visual features from a video, (ii) determining second information relating to motion vectors as a function of the first information, and (iii) computing a statistical representation of a plurality of frames of the video based on the second information. Further, the computing arrangement(s) can be configured to provide the statistical representation to a display device and/or recording the statistical representation on a computer-accessible medium, for example.

### CROSS-REFERENCE TO RELATED APPLICATION(S)

The present application relates to and claims priority from U.S. Patent Application No. 61/087,880, filed Aug. 11, 2008, the entire disclosure of which is hereby incorporated herein by reference.

### STATEMENT REGARDING FEDERALLY SPONSORED RESEARCH

The present disclosure was developed, at least in part, using Government support under Grant No. N000140710414 awarded by the Office of Naval Research and Grant Nos. 0329098 and 0325715 awarded by the National Science Foundation. Therefore, the Federal Government has certain rights in the present disclosure.

### FIELD OF THE DISCLOSURE

The present disclosure relates to system, method and computer accessible medium which can provide, e.g., speaker recognition and visual representation of motion that can be used to learn and classify body language of objects (e.g., people), e.g., while they are talking e.g., body signatures.

### BACKGROUND INFORMATION

Global news can inundate our senses with world leaders, politicians and other influential people talking about current policies, problems, and proposed solutions. Most viewers may believe that they value and/or do not value what these speakers may be saying because of the words that these speakers may be using and the speakers' face. However, experts in the field of communication typically agree that significant amount of communication is contained in non-verbal body language. The speakers' physical movement, or what can be termed body signature, can determine a major portion of the message and the recognition. Talk show hosts and political comedians may often capitalize on this phenomenon by actively using their own heightened sense of body movement to bring this aspect to consciousness for the viewers.

Human beings often make important decisions, such as whom to vote for, whom to work with, whom to marry, etc., by attuning to these body messages. Therefore, it can be important for various professionals, engineers and scientists to understand body movement more fully and include such body movement in body language recognition technology.

A person's whole body can send important signals. These signals can come from, e.g., the person's eyes, eyebrows, lips, head, arms and torso, all in phrased, often highly orchestrated movements.

Tracking visual features on people in videos can be difficult. It may be easy to find and track the face because it has clearly defined features, but the hands and clothes in standard video can be noisy. Self-occlusion, drastic appearance change, low resolution (e.g., the hands can be just a few pixels in size), and background clutter can make the task of tracking challenging. One recent implementation of people tracking recognizes body parts in each frame by probabilistic fitting kinematic color and shape models to the entire body. Tracking explicitly body parts can yield some success, but generally not to track the hands, for example, due to, e.g., relatively low-resolution web footage and/or low resolution display devices.

Acoustic speech as visual body language can depend on many factors, including, e.g., cultural background, emotional state and what is being said. One approach that has been proposed is a technique based on the application of Gaussian Mixture Models to speech features. Another possible approach is to apply a complete low-level phoneme classifier to high-level language model based recognition system. Another approach is to apply Support-Vector-Machines (SVM) to various different. Still other techniques have been proposed to recognize action, gait and gesture categories.

Despite these proposed approaches, there still appears to be a need for a robust feature detection system, method and computer-accessible medium that does not have to use explicit tracking or body part localization because, e.g., these techniques can often fail, especially with respect to low-resolution web-footage and television. Therefore, an exemplary embodiment of the detection system, method and computer-accessible medium that can reliably report a feature vector regardless of the complexity of the input video can be highly desirable.

### SUMMARY OF EXEMPLARY EMBODIMENTS

To that end, it may be preferable to provide exemplary embodiments of system, method and computer accessible medium which can provide, e.g., speaker recognition and visual representation of motion that can be used to learn and classify body language of objects (e.g., people), e.g., while they are talking e.g., body signatures.

Certain exemplary embodiments of the present disclosure provided herein can include a computer-accessible medium containing executable instructions thereon. When one or more computing arrangements executes the instructions, the computing arrangement(s) can be configured to perform certain exemplary procedures, including (i) receiving first information relating to one or more visual features from a video, (ii) determining second information relating to motion vectors as a function of the first information, and (iii) computing a statistical representation of a plurality of frames of the video based on the second information. The computing arrangement(s) can be configured to provide the statistical representation to a display device and/or recording the statistical representation on a computer-accessible medium. The statistical representation can include at least in part a plurality of spatiotemporal measures of flow across the plurality of video frames, for example.

The exemplary statistical representation can include at least in part a weighted angle histogram which can be discretized into a predetermined number of angle bins. Each exemplary angle bin can contain a normalized sum of flow magnitudes of the motion vectors, which can be provided in a particular direction, for example. The values in each angle bin can be blurred across angle bins and/or blurred across time. The blurring can be performed using a Gaussian kernel, for example. One or more exemplary delta features can be determined as temporal derivatives of angle bin values. Exemplary statistical representation can be used to classify video clips, for example. In certain embodiments, the classification can be performed only on clusters of similar motions. The motion vectors can be determined using, e.g., optical flow, frame differences, and/or feature tracking. The exemplary statistical representation can include an exemplary Gaussian Mixture Model, an exemplary Support Vector Machine and/or higher moments, for example.

Also provided herein, for example, are certain exemplary embodiments of the present disclosure that can include a computer-accessible medium containing executable instructions thereon. When the exemplary instructions are executed by a processor, the instructions can configure the processor to perform the following operations for analyzing video, including (i) receiving first information relating to one or more visual features from a video, (ii) determining second information in each feature frame relating to motion vectors as a function of the first information, (iii) determining a statistical representation for each video frame based on the second information, (iv) determining a Gaussian mixture model over the statistical representation of the frames in a video in a training data-set, and (v) obtaining one or more a super-features relating to the change of Gaussian mixture models in a specific video shot, relative to the Gaussian mixture model over the entire training data-set.

According to certain exemplary embodiments, the exemplary motion vectors can be determined at locations where the image gradients exceed a predetermined threshold in at least two directions, for example. The exemplary statistical representation can be a histogram based on the angles of the motion vectors, for example. In certain exemplary embodiments, the exemplary histogram can be weighted by the motion vector length and normalized by the total sum of all motion vectors in one frame. An exemplary delta between histograms can be determined. Further, one or more exemplary super-features can be used to find exemplary clusters of similar motions, for example. The exemplary processing arrangement(s) can also be configured to locate the clusters using a Bhattacharya distance and/or spectral clustering, for example. The exemplary super-features can also be used for classification with a discriminate classification technique, including an exemplary Support-Vector-Machine, for example. The exemplary processing arrangement(s) can be configured to use the super-features and one or more exemplary Support Vector Machines on acoustic features and visual features together, such as when the first information further relates to acoustic features, for example.

Additionally, according to certain exemplary embodiments, the classification may only be done on the clusters of similar motions. In certain exemplary embodiments, the procedures described herein may be applied to at least one person in a video. In certain exemplary embodiments, the procedures described herein may be applied to one or more people while they are speaking. A face-detector may be used that can compute the exemplary super-features only around the face and/or the body parts below the face, for example. According to certain exemplary embodiments, an exemplary shot-detection scheme can be applied first, then, the exemplary computer accessible medium can compute the super-features only inside an exemplary shot. Further, the exemplary processing arrangement(s) can be configured to, using only MOS features, compute at an exemplary L1 distance and/or an exemplary L2 distance to templates of other MOS features. The exemplary L1 distance and/or the exemplary L2 distance can be computed with a standard sum of frame based distances and/or dynamic time warping, for example.

In addition, according to certain exemplary embodiments of the present disclosure, a method for analyzing video is provided that can include, for example, (i) receiving first information relating to one or more visual features from a video, (ii) determining second information relating to motion vectors as a function of the first information, and (iii) computing a statistical representation of a plurality of frames of the video based on the second information. The exemplary method can also include, e.g., providing the statistical representation to a display device and/or recording the statistical representation on a computer-accessible medium. The exemplary statistical representation can include at least in part a plurality of exemplary spatiotemporal measures of flow across the plurality of frames of the video, for example.

Further, according to certain exemplary embodiments of the present disclosure, a method for analyzing video is provided that can include, for example, (i) receiving first information relating to one or more visual features from a video, (ii) determining second information in each feature frame relating to motion vectors as a function of the first information, (iii) computing a statistical representation for each video frame based on the second information, (iv) computing a Gaussian mixture model over the statistical representation of all frames in a video in a training data-set, and (v) computing one or more a super-features relating to the change of Gaussian mixture models in a specific video shot, relative to the Gaussian mixture model over the entire training data-set.

These and other objects, features and advantages of the present invention will become apparent upon reading the following detailed description of exemplary embodiments of the present disclosure, when taken in conjunction with the appended claims.

These and other objects, features and advantages of the present invention will become apparent upon reading the following detailed description of exemplary embodiments of the present disclosure, when taken in conjunction with the appended claims.

### BRIEF DESCRIPTION OF THE DRAWINGS

Further objects, features and advantages provided by the present disclosure will become apparent from the following detailed description taken in conjunction with the accompanying figures showing illustrative embodiments, in which:

FIG. 1 is an illustration of a set of exemplary video frames or clips of motion signatures in accordance with certain exemplary embodiments of the present disclosure;

FIGS. 2(a) and 2(b) are illustrations of exemplary face and body tracking frames and fixed areas for motion histogram estimation in accordance with certain exemplary embodiments of the present disclosure;

FIG. 3 is a set of illustration of exemplary video frames in accordance with certain exemplary embodiments of the present disclosure;

FIG. 4 is an exemplary graph of average classification errors in accordance with certain exemplary embodiments of the present disclosure;

FIG. 5 is an exemplary block diagram of audio-visual integration in accordance with certain exemplary embodiments of the present disclosure;

FIG. 6 is an illustration of a set of further exemplary video clips in accordance with certain exemplary embodiments of the present disclosure;

FIG. 7(a) is an exemplary graph of a set of an equal error rates in accordance with one exemplary embodiment of the present disclosure;

FIG. 7(b) is an exemplary graph of a set of equal error rates in accordance with another exemplary embodiment of the present disclosure;

FIG. 7(c) is an exemplary graph of a set of equal error rates in accordance with still another exemplary embodiment of the present disclosure;

FIG. 8 is an illustration of exemplary spectral clusters in accordance with certain exemplary embodiments of the present disclosure;

FIG. 9 is a graph of exemplary average classification errors in accordance with certain exemplary embodiments of the present disclosure;

FIG. 10 is a flow diagram of an exemplary process being performed in a system in accordance with certain exemplary embodiments of the present disclosure;

FIG. 11 is a flow diagram of another exemplary process being performed in a system in accordance with certain exemplary embodiments of the present disclosure;

FIG. 12 is a flow chart of a procedure for analyzing video in accordance with certain exemplary embodiments of the present disclosure;

FIG. 13 is a block diagram of a system and/or arrangement configured in accordance with certain exemplary embodiments of the present disclosure, e.g., for analyzing video; and

FIG. 14 is a flow diagram of another exemplary process being performed in a system in accordance with certain exemplary embodiments of the present disclosure.

Throughout the figures, the same reference numerals and characters, unless otherwise stated, are used to denote like features, elements, components or portions of the illustrated embodiments. Moreover, while the present disclosure will now be described in detail with reference to the accompanying figures, it is done so in connection with the illustrative embodiments. It is intended that changes and modifications can be made to the described embodiments without departing from the true scope and spirit of the present disclosure.

### DETAILED DESCRIPTION OF EXEMPLARY EMBODIMENTS

Provided and described herein are, e.g., exemplary embodiments of systems, methods, procedures, devices, computer-accessible media, computing arrangements and processing arrangements in accordance with the present disclosure related to body signature recognition and acoustic speaker verification utilizing body language features.

Exemplary embodiments in accordance with the present disclosure can be applied to, e.g., several hours of internet videos and television broadcasts that can include, e.g., politicians and leaders from, e.g., the United States, Germany, France, Iran, Russia, Pakistan, and India, and public figures such as the Pope, as well as numerous talk show hosts and comedians. Dependent on the complexity of the exemplary task sought to be accomplished, e.g., up to approximately 80% recognition performance and clustering into broader body language categories can be achieved.

Further provided herein are, e.g., exemplary systems, methods, procedures, devices, computer-accessible media, computing arrangements and processing arrangements which can facilitate with a determination as to these additional signals can be processed, the sum of which can be called, but not limited to, “body signature.” Every person can have a unique body signature, which exemplary systems and methods according to the present disclosure are able to detect using statistical classification techniques. For example, according to certain exemplary embodiments of the present disclosure, in one test, 22 different people of various different international backgrounds were analyzed while giving speeches. The data is from over 3 hours of video, downloaded from the web, and recorded from broadcast television. Among others, the data include United States politicians, leaders from Germany, France, Iran, Russia, Pakistan and India, the Pope, and numerous talk show hosts and comedians.

Further, certain video-based feature extraction exemplary systems, methods, procedures, devices, computer-accessible media, computing arrangements and processing arrangements are provided herein that can, e.g., train statistical models and classify body signatures. While certain exemplary embodiments of the present disclosure can be based on recent progress in speaker recognition research, compared to acoustic speech, body signature tends to be significantly more ambiguous because, e.g., a person's body has many parts that can be moving simultaneously and/or successively. Despite the more challenging problem of body signature recognition, e.g., up to approximately 80% recognition performance on various tasks with up to 22 different possible candidates can be achieved according to the present disclosure, in one test.

Additionally, certain visual feature estimation exemplary systems, methods, procedures, devices, computer-accessible media, computing arrangements and processing arrangements based on sparse flow computations and motion angle histograms can be provided, which can be called Motion Orientation Signatures (MOS), and certain integration of such exemplary systems, methods, procedures, devices, computer-accessible media, computing arrangements and processing arrangements into an exemplary 3-stage recognition system (e.g., Gaussian Mixture Models, Super-Features and SVMs).

Certain exemplary embodiments of the present disclosure can build on, e.g., the observation that it is relatively easy to track just a few reliable features for a few frames of a video as opposed to tracking body parts over the entire video. Based on such exemplary short-term features at arbitrary unknown locations, an implicit exemplary feature representation can be employed in accordance with exemplary embodiments of the present disclosure. Also provided herein are, e.g., exemplary systems and procedures for using what can be referred to as GMM-Super-Vectors.

### Exemplary Visual Feature Extraction: Motion Orientation Signatures (MOS)

In addition, provided herein are exemplary embodiments of a feature detecting method, system and computer-accessible medium that does not have to use explicit tracking or body part localization, which, as discussed above, can often fail, especially with respect to low-resolution web-footage and television, for example. Further provided herein is a feature extraction process, system and computer accessible medium according to the present disclosure that can report a feature vector regardless of the complexity of the input video.

### Exemplary MOS: Motion Orientation Signatures

According to certain exemplary embodiments of the present disclosure, the first procedure can include a flow computation at reliable feature locations. Reliable features can be detected with, e.g., the Good Features technique. The flow vectors can then be determined with a standard pyramidal Lucas & Kanade estimation. Based on these exemplary determined flow vectors (or flow estimates), a weighted angle histogram can be computed. For example, the flow directions can be discretized into N angle bins. N can be a number within the range of 2 to 80, for example, although it may be preferable for N to be a number within the range of, e.g., 6 to 12, such as 9. The selected number for N can affect the recognition performance. Each angle bin can then contain a sum of the flow magnitudes in this direction, e.g., large motions can have a larger impact than small motions.

Flow magnitudes larger than a certain maximum value can be clipped before adding it to the angle bin to make the angle histogram more robust to outliers. For example, most or all of the bin values can then be normalized by dividing them by the number of total features, for example, which can factor-out fluctuations that may be caused by, e.g., a different number of features found in different video frames. The bin values can then be blurred across angle bins and/or across time with, e.g., a Gaussian kernel (e.g., sigma=1 for angles and sigma=2 for time). This exemplary procedure can reduce or even avoid aliasing effects in the angle discretization and across time.

Many web videos can have only 15 frames per second (fps), for example, while other videos can have 24 fps and be up-sampled to 30 fps. After the spatio-temporal blurring, the histogram values can be further normalize to values of, e.g., 0 to 1 over a temporal window such as t=10. Temporal windows can be within a range of, e.g., 1 to 100 and may preferably be a range of 2-20. This can factor-out, e.g., video resolution, camera zoom and body size since double resolution can create double flow magnitudes; but may also factor out important features. This can be because certain people's motion signature can be based on subtle motions, while other people's motion signatures can be based on relatively large movements. For this exemplary reason, according to certain exemplary embodiments of the present disclosure, it can be preferable to keep the normalization constant as one extra feature.

Similarly to acoustic speech features, which can be normalized to factor out microphone characteristics, delta-features, the temporal derivative of each orientation bin value, can be determined in accordance with certain exemplary embodiments of the present disclosure. Since the bin values can be statistics of the visual velocity (e.g., flow), the delta-features can cover, e.g., acceleration and deceleration. For example, if a subject claps his/her hands fast, such clapping can produce large values in the bin values that can cover about 90° and 270° (left and right motion), and also large values in the corresponding delta-features. In contrast, if a person merely circles his/her hand with a relatively constant velocity, the bin values can have large values across all angles, and the corresponding delta-features can have low values.

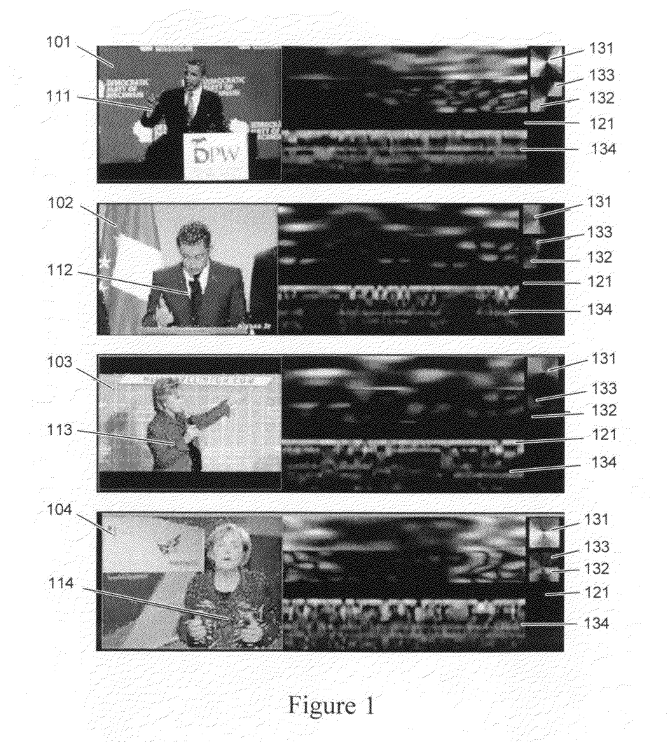

FIG. 1 shows certain examples of motion signatures in accordance with certain exemplary embodiments of the present disclosure. In particular, FIG. 1 illustrates certain exemplary signatures that can be created with certain video input in accordance with certain exemplary embodiments of the present disclosure. As can be seen in FIG. 1, for example, several politicians are shown in video clips 101, 102, 103, 104, performing different hand waving motions. The corresponding exemplary motion signatures 111, 112, 113, 114 are shown to the right of each respective exemplary video clip 101, 102, 103, 104. As shown within each of the motion signatures 111, 112, 113, 114, the top rows 121 show the angle bin values over time. The middle rows 122, 123, which are positive and negative, respectfully, show the delta-features over time. The bottom rows 124 show the acoustic features.

One sample aspect of this exemplary feature representation that can be significant is that it can be invariant to the location of the person. Because the flow vectors can be determined only at reliable locations, and large flow vectors can be clipped, the histograms can also be robust against noise.

### Exemplary Coarse Locality

In many videos, most of the motion can come from the person giving the speech, while background motion can be relatively small and uniformly distributed, so it may have no significant effect on the corresponding histogram. In such exemplary cases, the histograms can be computed over the entire video frame. According to certain exemplary embodiments, local region of interests (ROIs) that can be, e.g., computed on fixed tile areas of a N×M grid or only focus on the person of interest in running an automatic face detector first can be utilized.

### Exemplary Face And Body Tracking

Certain exemplary face-detection algorithms or procedures have been used, such as the Viola-Jones detector, that find with relatively high reliability the location and scale of a face within a video. Full-body detection systems, methods and software can also be used, while possibly not achieving a desired accuracy.

In order to further reduce or eliminate false positives and false negatives, the following exemplary procedure can be utilized: When an exemplary face detection systems, methods, computer-accessible medium and software returns an alleged match, it may not immediately be assumed that there is a face in that region since the alleged match may be a false positive. Rather, e.g., it can first be confirmed the alleged match in that area of the exemplary video image by performing the face detection over the next several frames. Upon a face being confirmed in this manner, certain exemplary embodiments according to the present disclosure can facilitate an extrapolation of a bounding region (e.g., rectangle) around the face that is large enough to span the typical upright, standing, human body. In this exemplary manner, a face region and a body region in the video frame can be defined and/or confirmed.

Since certain exemplary embodiments according to the present disclosure can compute sparse flow on the entire image for Motion Orientation Signatures (MOS) features, those exemplary features can also be used to update the location of the face within a video clip. Certain exemplary embodiments can be used to determine the average frame-to-frame flow of the flow vectors inside the face region, the location of the face within the video can be update in the next frame. According to certain exemplary embodiments of the present disclosure, the face-detector can be run, e.g., every 10th frame again to provide confirmation that the features have not significantly drifted. If the face region can not be confirmed by the face-detector after the 10th or the 20th frame, the region of interest can be discarded. This exemplary procedure can be more robust, then, e.g., running the face-detection system, method or software on each frame. This can be because sometimes the person in the video may turn to the side and/or back frontal, which typically can make the face-detector fail, while the exemplary sparse flow vectors according to certain embodiments of the present disclosure can keep track of the face location.

In addition to the exemplary advantage of discarding flow features from the background, by using only the features that are inside the face location region and/or the derived lower body location region, another advantage can be, e.g., to determine two separate motion histograms, one for the face and one for the body, instead of only one motion histogram for the entire frame. When there is not a successful face detection, it is possible that no MOS features can be determined for those frames. Nevertheless, a better exemplary recognition performance can still be achieved, such as, e.g., 4-5% according to certain exemplary embodiments.

### Exemplary Static Grid Areas

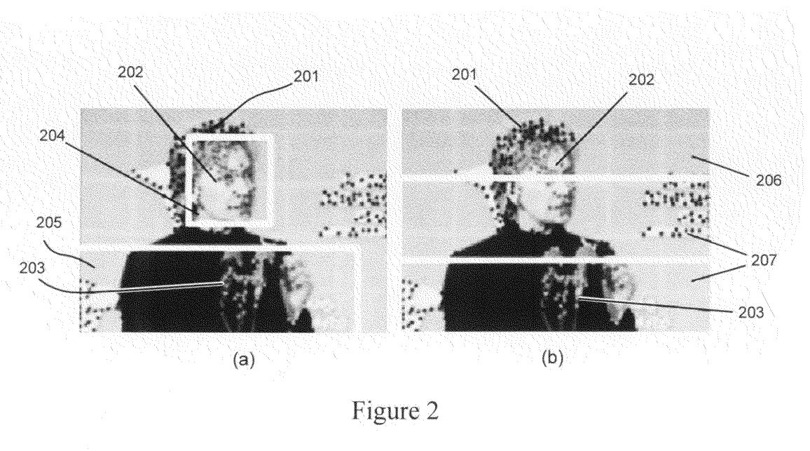

FIG. 2 illustrates certain examples of face and body tracking and fixed areas for motion histogram estimation in accordance with certain exemplary embodiments of the present disclosure. As shown in FIGS. 2(a) and 2(b), a subject 201 has a face 202 and a body 203. FIG. 2(a) shows an exemplary face and body tracking using an exemplary region 204, corresponding to face 202, and an exemplary region 205, corresponding to body 203. Certain exemplary procedures for determining features that capture coarse location information can include computing exemplary motion histograms inside regions that are defined by a static grid. Many different grid sizes can be used. For example, as illustrated in FIG. 2(b), according to certain exemplary embodiments, two overlapping coarse regions can be defined, where, e.g., the exemplary top region 206 extends horizontally across the entire frame and covers the top ⅔ of the frame, while the exemplary bottom region 207 also covers horizontally the entire frame and the bottom ⅔ of the frame, for example. With this exemplary representation, two exemplary motion histograms can be determined and an average of, e.g., about 5% better recognition performance can be achieved. Although the top ⅔ of the exemplary video shown FIG. 2(b) can include part of the body 203 in addition to the face 202, and the bottom ⅔ of the exemplary video can include part of the face 202 in addition to the body 203, the corresponding histograms can differ, and the difference between the histograms can contain, e.g., information as to what may be different between the head motion and body motion. This exemplary representation can be preferable since it may not be dependent on face-detection failures. According to certain exemplary embodiments, it can be preferred to determine both representations, e.g., face-based and grid-based motion histograms.

### Exemplary Other Low-Level Processing

Exemplary motion histogram normalization can partially compensate for, e.g., camera zoom. Two exemplary alternatives to estimate camera motion include Dominant Motion Estimation and a heuristic that uses certain exemplary grid areas at the border of the video frame to estimate background motion. Once the background motion is estimated, it can be subtracted from the angle histograms, for example. In addition, different exemplary scene cut detection procedures can be utilized. For example, recording from television and/or the world wide web can utilize scene cut detection since those videos are typically edited.

If the footage is coming from television or the world wide web, it may be edited footage with scene cuts. It can be preferable for certain exemplary embodiments according to the present disclosure to operate on one shot (e.g., scene) at a time, not an entire video. At shot boundaries, exemplary motion histograms can drastically change, which can be used for segmenting scenes. According to certain exemplary embodiments, additionally computed histograms over the color-values in each frame can be used. If the difference between color-histograms is above an exemplary specified threshold (using, e.g., an exemplary histogram intersection metric), then the video can be split. According to certain exemplary embodiments, with shots that are longer then 5 minutes (e.g., a speech), an exemplary shot-detection system, method or software can cut the video into, e.g., 5 minute shots. Certain exemplary shots can be very short (e.g., 1-10 seconds) seconds. Exemplary shots that are less than 5 seconds in length can be discarded, for example. Additional shot-detection methods and procedures can be used in certain exemplary embodiments in accordance with the present disclosure.

### Exemplary Video Shot Statistics: GMM-Super-Features

According to one example, each video shot can be between, e.g., 5 seconds and 5 minutes long, which can equal a range of, e.g., 150 time frame shots to 10,000 time frame shots of motion angle histograms features. Shots can be separated into a training and an independent test set, for example. Exemplary test sets can be, e.g., from recordings on different dates (as opposed to, e.g., different shots from the same video). For each subject, there can be videos from, e.g., 4 to 6 different dates. Some of the videos can be just a few days apart, while others can be many years apart. The training shots can be labeled with the persons name (e.g., shot X is Bill Clinton, shot Y is Nancy Pelosi). Unlabeled shots can also be utilized so that both labeled and unlabelled shots can be used to learn biases for exemplary feature representations. Exemplary shot statistics according to the exemplary embodiments of the present disclosure can be based on, e.g., exemplary GMM-Super-Features and SVMs. Other exemplary architectures, which can be more complex, may also be used.

A exemplary Gaussian Mixture Model (GMM) can be trained on the entire database with a standard Expectation Maximization (EM) algorithm. A different number of Gaussians can be used, such as, e.g., 16 Gaussians per Mixture Model, which got best recognition performance. It can also be preferable to use any number within the range of, e.g., 8 and 32 Mixtures. According to certain exemplary embodiments, e.g., using a number of less than 8 can yield a degradation of the exemplary recognition performance. This can be called, e.g., a Universal Background Model (UBM).

With an exemplary UBM model, the statistics of each shot can be determined in MAP adapting the GMM to the shot. This can be done, e.g., with another EM step. The M step may not completely update the UBM model, but may rather use a tradeoff as to how much the original Gaussian is weighted versus the new result from the M-step, for example. An exemplary GMM-Super-Feature can be defined as the difference between the UBM mean vectors and the new MAP adapted mean vectors. For example, if the shot is similar to the statistics of the UBM, the difference in mean vectors can be very small. If the new shot has some unique motion, then at least one mean vector can have a large difference to the UBM model. An exemplary GMM-Super-Feature can have a fixed-length vector that describes the statistics of an exemplary variable length shot, for example. In accordance with certain exemplary embodiments of the present disclosure, such exemplary vectors can be used for classification and clustering.

### Exemplary Recognition And Clustering Experiments

### Exemplary SVM Based Classification

According to certain exemplary embodiments of the present disclosure, exemplary GMM-Super-Features can be provided to a standard SVM classifier procedure in further scaling the way with the mixing coefficients and covariances of an exemplary GMM model. For example, a linear SVM kernel can provide a good approximation to the Kl divergence between two utterances. It may be preferred to model this exemplary property. A large distance between the Super-Features of two shots in an exemplary SVM hyper plane can correspond to a relatively large statistical difference between the shots. According to certain exemplary embodiments, a multi-class extension of the SVM-light package can be used.

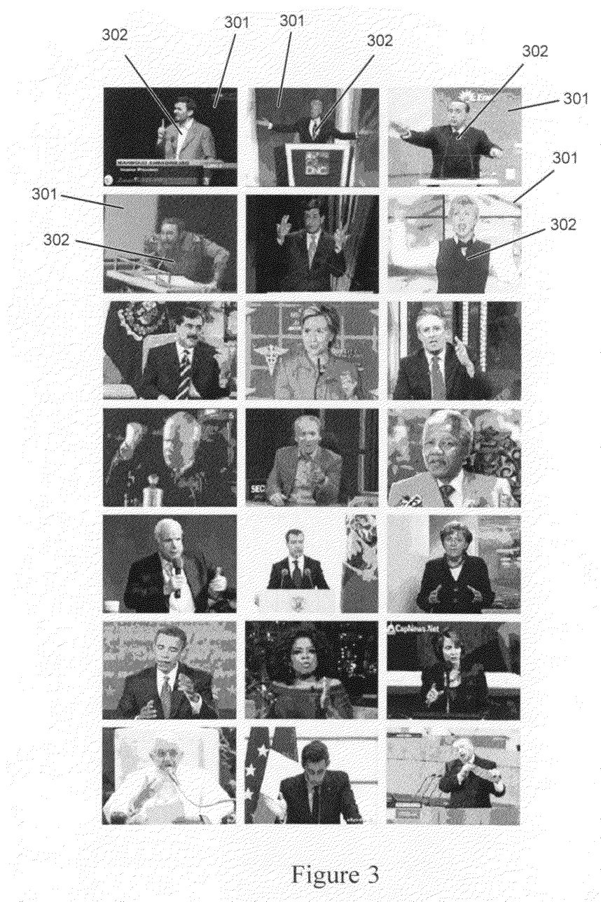

FIG. 3 shows certain example video frames 301 that can be stored in a database. As shown in the examples of FIG. 3, there can be twenty-one different exemplary subjects 302. In certain exemplary embodiments, twenty-two subjects can be utilized. The number of subjects can range from 2 to 200 according to certain exemplary embodiments, and there could even be more (e.g., up to 2000, 20,000, etc.), or only one subject according to certain exemplary embodiments. In the exemplary embodiment in which twenty-two subjects are utilized, there can be at least four different videos for each subject. In certain exemplary embodiments, there can be up to six different videos or more (e.g., up to 50, 100, etc.) of each subject. The different videos can be recorded at different times. Each video can be, e.g., between 5 seconds to 5 minutes in length. Longer videos, e.g., up to half an hour, one hour, two hours, etc., can also be utilized in accordance with certain exemplary embodiments. For example, a database can include, e.g., (in alphabetical order) Mahmoud Ahmadinejad, Silvio Berlusconi, Fidel Castro, Bill Clinton, Hillary Clinton, Stephen Colbert, Ellen DeGeneres, Yousaf Gillani, Nikita Khrushchev, Bill Maher, Nelson Mandela, John McCain, Dmitry Medvedev, Angela Merkel, Barack Obama, Nancy Pelosi, Pope Benedict XVI, Nicolas Sarkozy, Manmohan Singh, Jon Stewart, Oprah Winfrey and Vladimir Volfovich Zhirinovsky.

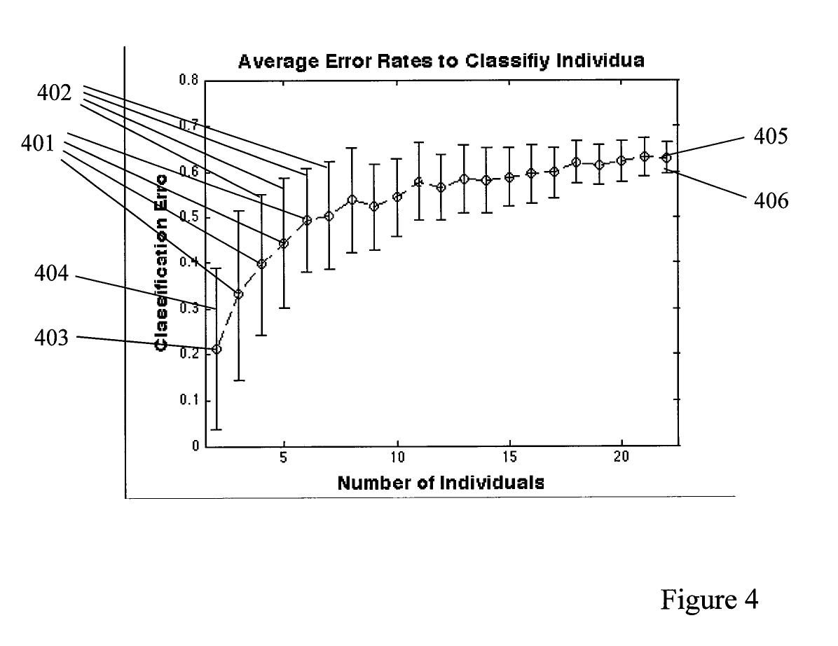

FIG. 4 shows a graph of exemplary recognition rates using the exemplary database of twenty-two subjects discussed above. The performance on various subsets can be measured. For example, recognizing one out of two people can generally be a significantly easier task then recognizing one out of twenty-two people. Each exemplary classification error 401 shown in the graph of FIG. 4 can be the average of, e.g., 100 experiments. In each exemplary experiment, the subset of N number of people can be randomly picked, and the videos can be randomly split into an exemplary training set and an exemplary test. In other exemplary embodiments, the subset of N number of people can be selected based on a predetermined percentage, for example. The exemplary GMMs, super-features and SVMs can first be trained on the exemplary training set (e.g., 2-3 videos for each category), then be tested on the exemplary independent test set. As shown in FIG. 4, for two-people classification 402, an average of approximately 80% correct performance can be achieved, but the corresponding variance 432 in performance values can be relatively large. This can be a because some pairs of subjects may be more difficult to distinguish, as well as that there may be less video data on some subjects than other subjects, for example.

As can also be seen in FIG. 4, for 22-people classification 422, the accuracy can be approximately 37%, which, although not as high as the exemplary accuracy 402 of approximately 80%, the accuracy for the 22 people classification 422 is valuable certain exemplary embodiments of the present disclosure in which it may be preferred to have a higher number of people classification. As is discussed herein, for example, the accuracy of a larger number of people classification can be improved when used in concert with an exemplary acoustic speaker recognition system in accordance with the present disclosure. For example, an improvement of exemplary acoustic speaker recognition rates can be achieved when including visual feature recognition. As is also shown in FIG. 4, the corresponding variance 442 in performance values can be relatively small.

Broader body language categories can also be classified in accordance with certain exemplary embodiments of the present disclosure. For example, several subjects may have similar body language, so it can be useful to classify broader categories that several subjects share.

According to certain exemplary embodiments of the present disclosure, exemplary acoustic speaker verification can be improved with the integration of exemplary visual body language features, such as, e.g., with audio-visual lip-reading tasks. Exemplary integration can performed at different abstraction levels. According to certain exemplary embodiments, there can be at least two different possible integration levels, e.g., i) at the feature level, where, e.g., the exemplary GMMs can be computed over the exemplary concatenated acoustic and visual vectors, and ii) after an exemplary super-feature calculation, e.g., before they are fed into the SVM (the GMM-UBM clustering and the MAP adaption can be performed separately). According to certain exemplary embodiments, the exemplary second integration method can be preferred, while according to other exemplary embodiments, the first exemplary integration method can be used (e.g., when using a relatively very large database providing for more mixture models without over-fitting).

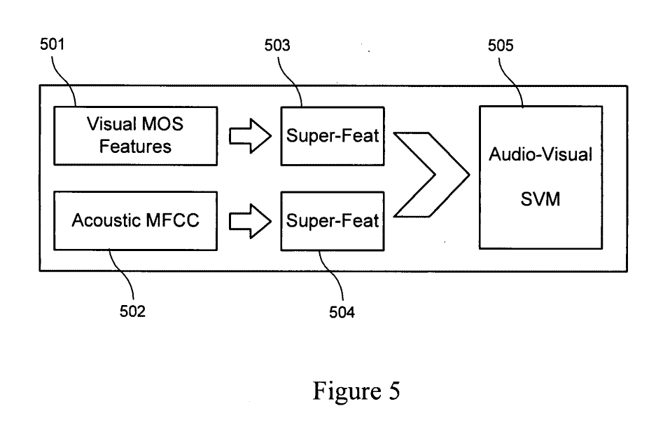

FIG. 5 shows an exemplary diagram of an exemplary system architecture in accordance with an exemplary embodiment of the present disclosure. For the exemplary acoustic front-end, certain embodiments can use standard Mel Frequency Cepstral Coefficient (MFCC) features (e.g., 12 Cepstral values, 1 energy value, and delta values). As shown in FIG. 5, for example, exemplary visual MOS features 501 and exemplary Acoustic MFCC 502 can be converted into superfeatures 503 and 504, respectively, to collectively form exemplary Audio-Visual SVM 505.

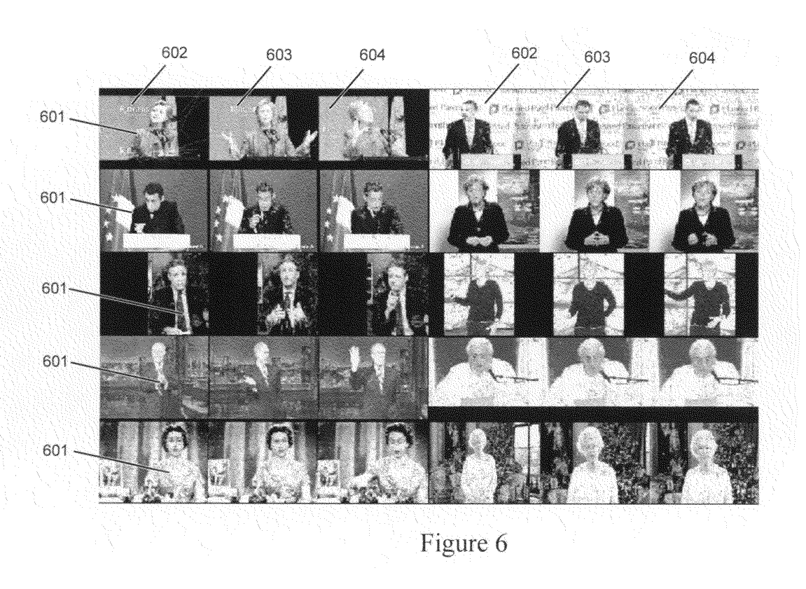

For example, using half of an exemplary set of 1556 shots of random YouTube videos and 208 shots of 9 exemplary subjects 601, each shown in sequences of 3 example video frames 602, 603 and 604, as shown in FIG. 6, several exemplary SVM architectures can be trained. According to certain exemplary embodiments, numerous trials or tests can be executed, such as, e.g., 90, with different divisions between exemplary training sets and exemplary test sets for, e.g., seven different exemplary scenarios. While certain exemplary embodiments can determine or locate the number of trials to be executed to be in the range of, e.g., 70-110, a range of the number of trials can be, e.g., from 1 to 100. The seven exemplary scenarios can be, e.g., 1) clean acoustic speech, 2) acoustic speech with 17 dB of background noise (such as, e.g., may be recorded in a pub including other chatter and noises), 3) acoustic speech with, e.g., 9.5 dB of background noise, 4) visual data only, and 5-7) three different exemplary noise-degraded acoustic speech data sets combined with visual speech. Exemplary embodiments in accordance with the present disclosure can reduce the acoustic-only error rate by incorporating visual information.

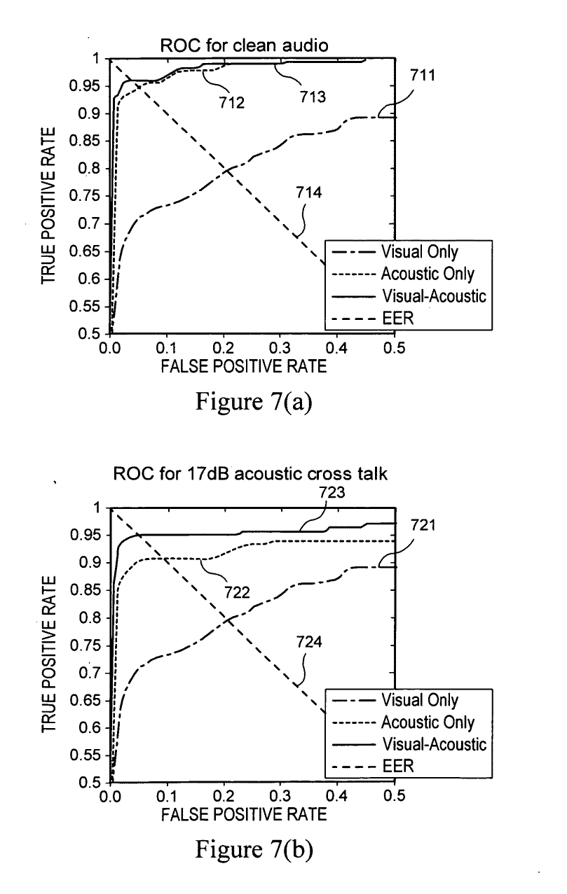

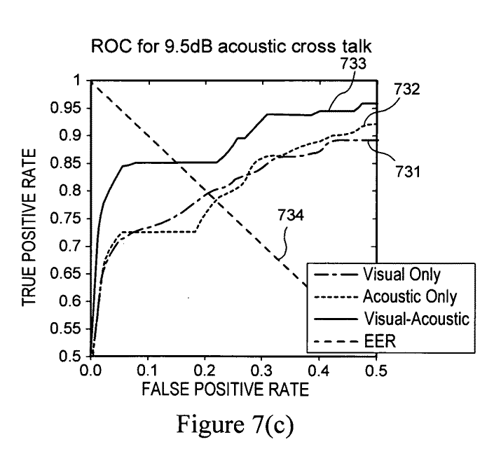

For example, FIG. 7(a) shows a graph in which, in exemplary environments with relatively clean acoustic data, an exemplary visual-only error rate 711 of approximately 20% and an acoustic only equal error rate 712 of approximately 5% can be reduced to approximately 4% using audio-visual input. This can be seen in FIG. 7(a) whereas the audio-visual equal error rate 713 intersects with EER 714. As shown in the exemplary graph of FIG. 7(b), a more dramatic improvement of visual-only and/or acoustic-only equal error rates in an approximately 17 dB SNR environment can be achieved. For example, as shown in FIG. 7(b), a visual-only EER 721 of approximately 20% can cause an acoustic-only EER of approximately 10% to decrease to an audio-visual EER of approximately 5%. Thus, when integrating exemplary visual input with exemplary acoustic-only input, the resultant audio-visual EER can be approximately half of that of the audio-only EER. As shown in the exemplary graph of FIG. 7(c), in an approximately 9.5 dB SNR (e.g., heavier acoustic noise) environment, an exemplary visual-only equal error rate 731 of approximately 20% can cause an exemplary acoustic-only EER 732 of approximately 22% to be decreased to an audio-visual equal error rate 733 of approximately 15%.

### Exemplary Body Language Clustering

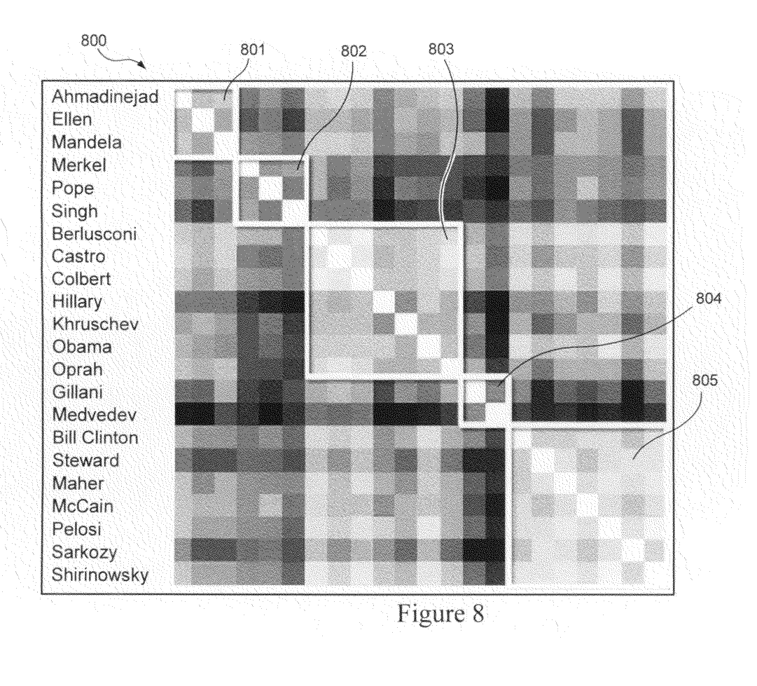

According to certain exemplary embodiments of the present disclosure, and exemplary multi-class spectral clustering procedure can be applied to exemplary Super-Feature vectors to, e.g., identify, e.g., sub-groups of subjects with similar body language. FIG. 8 shows an exemplary distance matrix 800 of the exemplary set of twenty-two subjects listed above based on exemplary Bhattacharya distances between exemplary Super-Vectors. These exemplary distances can measure a similar metric as a KL-divergence can be used for SVM experiments, for example. An exemplary multi-class spectral clustering procedure can be used for several different number of clusters, and an exemplary SVM system can be re-trained for the different cluster categories instead of individual target values, for example. The lighter shades within the exemplary matrix 800 can denote shorter distances between Super-Vectors. As can be seen in the example depicted in FIG. 8, the number of exemplary clusters can be 5 (e.g., 801, 802, 803, 804 and 805).

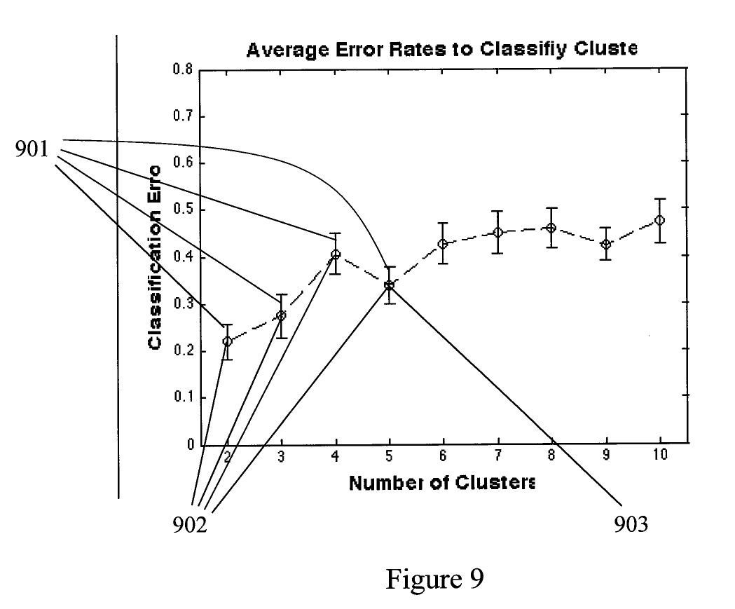

FIG. 9 shows a graph of exemplary recognition rates 901 having corresponding variances 902 in accordance with certain exemplary embodiments of the present disclosure (e.g., based on an exemplary average of approximately 100 randomly splits between test and training sets). As can be seen in FIG. 9, using exemplary clusters can significantly improve the performance. For example, an error rate 903 of only approximately 33% can be achieved based on a five-category problem using 5 clusters. In comparison, an error rate 401 of approximately 50% can result when using, e.g., 5 clusters, as can be seen in the graph of FIG. 4, for example.

Exemplary systems in accordance with certain exemplary embodiments of the present disclosure can be part of an exemplary larger multi-modal system that can also use, e.g., face recognition, acoustic speaker verification and other modalities. Corresponding exemplary recognition rates that can be achieved may be used to further boost other recognition rates from the other modalities, for example.

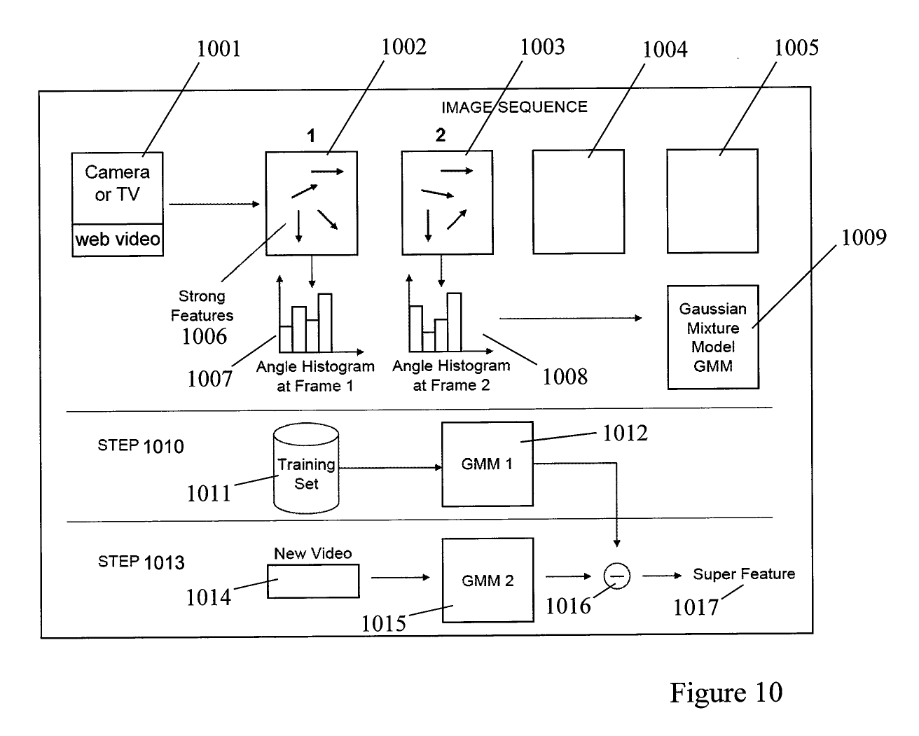

FIG. 10 illustrates an exemplary flow diagram of an exemplary process performed in a system in accordance with certain exemplary embodiments of the present disclosure. As can be seen in FIG. 10, for example, a camera, television or web video 1001 can generate and/or provide an image sequence of a number of exemplary video frames 1002, 1003, 1004 and 1005. Super Vectors 1006, e.g., indicating strong features, can be determined corresponding to the movement of subjects in the exemplary video frames 1001-1005. Exemplary angles histograms 107 and 108, corresponding to video frames 1006 and 1007, respectively, can be generated from the exemplary Super Vectors 1006. Exemplary histograms can be generated for each of the exemplary video frames 1002-1005. The exemplary angle histograms (e.g., 1007 and 1008) can be averaged to generate an exemplary Gaussian Mixture Model (GMM) 1009. Using this exemplary procedure, as shown in FIG. 10 (in 1010), an exemplary training set of exemplary video frames can be used to generate an exemplary Gaussian Mixture Model (GMM) 1012. Similarly, in 1013, exemplary new video 1014 can be used to generate an exemplary Gaussian Mixture Model (GMM) 1015. The two exemplary Gaussian Mixture Models (GMM) 1012 and 1015 can be combined at 1016 to generate an exemplary Super Feature 1017.

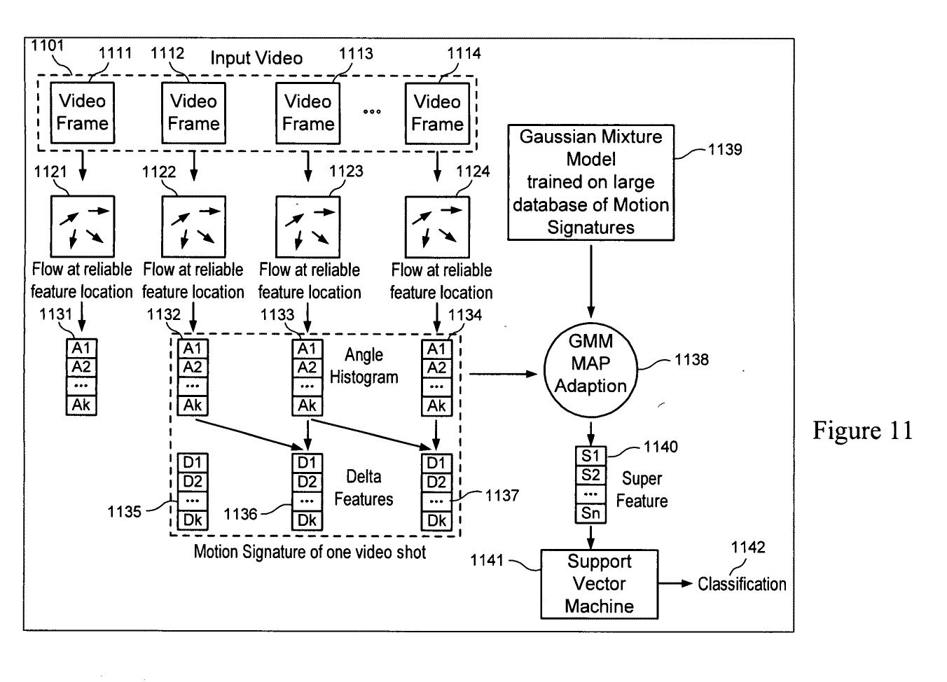

FIG. 11 illustrates a flow diagram of an example of another exemplary process performed in the system in accordance with certain exemplary embodiments of the present disclosure. As can be seen in FIG. 11, for example, input video 1101 (e.g., from a camera, television or web video) can generate and/or provide exemplary video frames 1111, 1112, 1113 and 1114. Super Vectors 1121, 1122, 1123 and 1124, e.g., indicating strong features, can be determined corresponding to the movement of subjects in the exemplary video frames 1111-1114, respectively. Exemplary angle histograms 1131, 1132, 1133 and 1134, corresponding to exemplary video frames 1111-1114, respectively, can be generated from the exemplary Super Vectors 1121-1124. Exemplary delta features 1135, 1136 and 1137 can be generated from the exemplary angle histograms 1131-1134, indicating changes in the features as denoted by the exemplary Super Vectors 1121-1124 corresponding to exemplary video frames 1111-1114, from which an exemplary Gaussian Mixture Model (GMM) MAP Adaption 1138 can be generated. The exemplary Gaussian Mixture Model (GMM) MAP Adaption 1138 can be combined with an exemplary Gaussian Mixture Model 1139 that has been trained on a large exemplary database of exemplary Motion Signatures to generate exemplary Super Features 1140. The exemplary Super Features 1140 can be used to generate an exemplary Support Vector Machine 1141 that can be used for exemplary classification 1142.

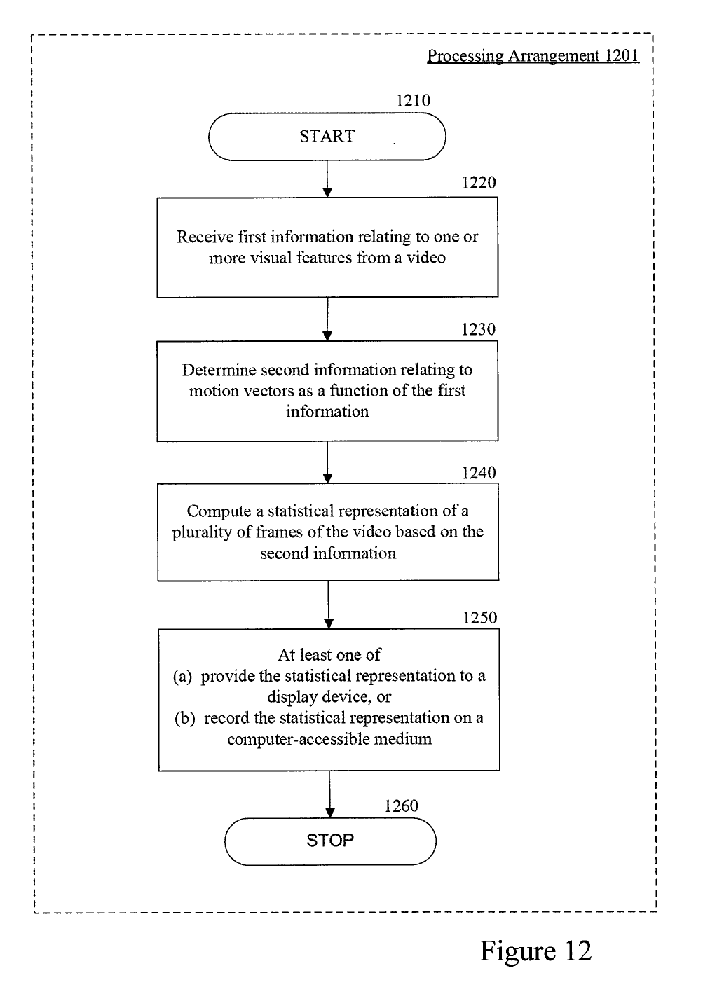

FIG. 12 illustrates a flow diagram of a procedure for analyzing video in accordance with certain exemplary embodiments of the present disclosure. As shown in FIG. 12, the procedure can be executed on and/or by a processing arrangement 1201 (e.g., one or more micro-processors or a collection thereof). Starting at 1210, the procedure can receive first information relating to one or more visual features from a video—1220. In 1230, the procedure can determine second information relating to motion vectors as a function of the first information. The procedure can then, in 1240, determine a statistical representation of a plurality of frames of the video based on the second information. Then, in 1250, the procedure can (a) provide the statistical representation to a display device and/or (b) record the statistical representation on a computer-accessible medium.

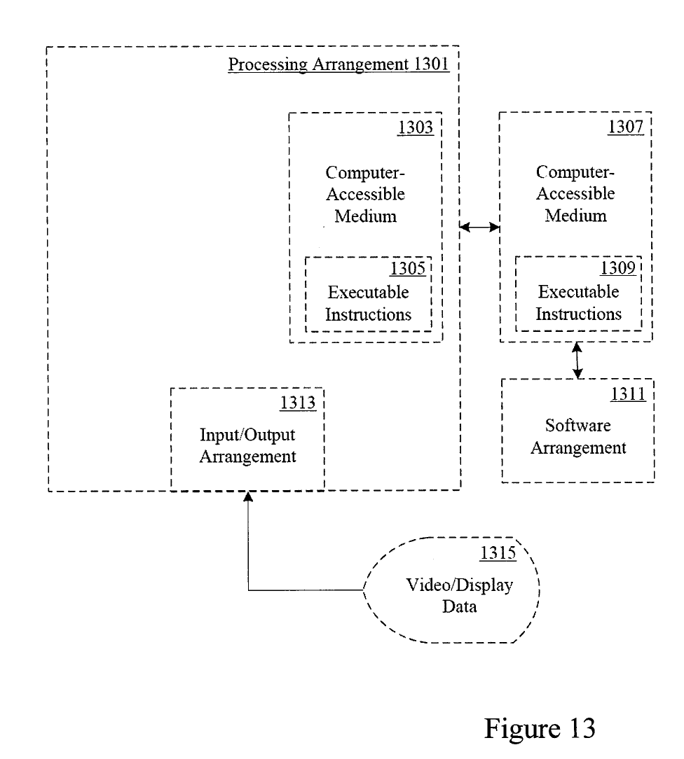

FIG. 13 is a block diagram of a system and/or arrangement configured in accordance with certain embodiments of the present disclosure for analyzing video, for example. As shown in FIG. 13, e.g., computer-accessible medium 1303 and 1307 (e.g., as described herein above, storage device such as hard disk, floppy disk, memory stick, CD-ROM, RAM, ROM, etc., or a collection thereof) can be provided (within and/or in communication with the processing arrangement 1301). The computer-accessible medium 1303 and 1307 can contain executable instructions 1305 and 1309 thereon, respectively. For example, when the processing arrangement 1301 accesses the computer-accessible medium 1303 and/or 1307, retrieves executable instructions 1305 and/or 1309 therefrom, respectively, and then executes the executable instructions 1305 and/or 1309, the processing arrangement 1301 can be configured or programmed to perform certain procedures for analyzing video.

For example, the exemplary procedures can include, e.g., receive first information relating to one or more visual features from a video, determine second information relating to motion vectors as a function of the first information, compute a statistical representation of a plurality of frames of the video based on the second information, and (a) provide the statistical representation to a display device and/or (b) record the statistical representation on a computer-accessible medium. In addition or alternatively, a software arrangement 1307 can be provided separately from the computer-accessible medium 1303 and/or 1307, which can forward the instructions or make available to the processing arrangement 1301 so as to configure the processing arrangement to execute, e.g., the exemplary procedures, as described herein above. The Processing arrangement 1301 can also include an input/output arrangement 1313, which can be configured, for example, to receive video and/or display data 1315. Examples of video and/or display data can include, e.g., television video, camera images (still and/or video) and/or video from the Internet and/or word wide web.

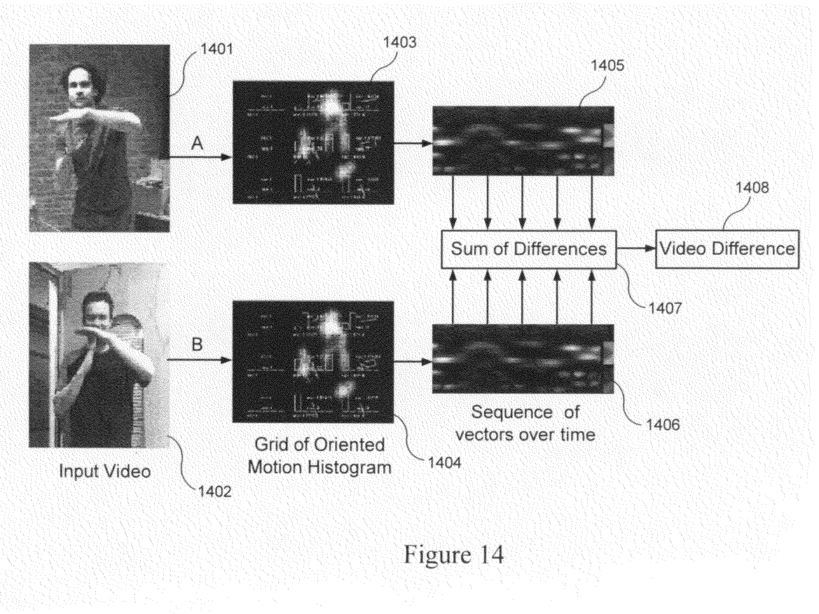

FIG. 14 illustrates another exemplary system and procedure in accordance with certain exemplary embodiments of the present disclosure that can determine and/or compute a distance between two or more videos (e.g., exemplary video A 1401 and exemplary video B 1402) without using, e.g., super-features, as can be used with other certain exemplary embodiments according to the present disclosure. Exemplary oriented motion angle histograms 1403 and 1404 (corresponding to exemplary video A 1401 and exemplary video B 1402, respectively) can be computed for each frame in each of exemplary video A 1401 and exemplary video B 1402, which can be performed, e.g., in a similar fashion to that described above with respect to exemplary embodiments using super-features.

For example, exemplary video A 1401 of N exemplary video frames can produce N exemplary vectors, and second exemplary video B 1402 of M exemplary video frames can produce M exemplary vectors. An exemplary distance 1408 between exemplary video A 1401 and exemplary video B 1402 can be determined and/or computed as follows. In exemplary embodiments where, e.g., N≦M, an exemplary video difference 1408 can be computed by computing the exemplary per-frame-vector-difference 1405 of exemplary video A 1401 frames 1 to N and the exemplary per-frame-vector-difference 1406 of exemplary video B 1042 frames 1 to N, and computing the exemplary sum 1407 of all such exemplary per-frame-vector-differences 1405, 1406. These exemplary procedures can be performed again for exemplary video A 1401 exemplary frames 1 to N and exemplary video B 1402 exemplary frames 2 to N+1, and again, summing the exemplary differences 1407. These exemplary procedures can be repeated for, e.g., all exemplary time offsets. The resulting exemplary minimum of all of the exemplary sum of differences 1407 can be interpreted as an exemplary difference 1408 between the exemplary video A 1401 and the exemplary video B 1402. Exemplary procedures can alternatively use, e.g., an exemplary Dynamic-Time-Warping technique and/or procedure, for example.

According to certain exemplary embodiments, an exemplary difference in measures between exemplary vector x and exemplary vector y can be computed and/or determined by computing an exemplary L1 norm (abs(x-y)) and/or an exemplary L2 norm (x-y)²). If an exemplary difference between the exemplary video A 1401 and the exemplary video B 1402 is relatively small, then it can be interpreted that the exemplary video A and the exemplary video B contain approximately the same or relatively similar gesture and/or motion, for example. An exemplary new input video can be compared to an exemplary set of stored videos in, e.g., a computer accessible storage device and/or database, and matched to an exemplary video in the exemplary set of stored videos by computing which exemplary video in the exemplary set of stored videos is the most similar to the exemplary new input video, for example.

Exemplary procedures using exemplary distances as described herein can match two or more exemplary videos based on their having, e.g., about the same or similar motion and gestures, as opposed to, e.g., an exemplary style-based match in accordance with other certain exemplary embodiments of the present disclosure in which the focus can be on matching exemplary similar motion styles. For example, exemplary procedures using exemplary distances as described herein can match, e.g., two or more dancers performing about the same or similar dance, as opposed to matching two or more exemplary dancers having about the same or similar dance style. As a further example, exemplary procedures using exemplary distances as described herein can match, e.g., two or more speakers performing about the same or similar hand gestures, as opposed to matching two or more speakers having about the same or similar body language style.

### Exemplary Simple Maximum LogLikelihood Classification

In order to visualize how the Motion Orientation Histograms and GMM-Super-Features can process the different example videos, a simpler classification method can be employed. For example, certain exemplary embodiments can compute an exemplary log-likelihood of an exemplary GMM model for each time-frame. The exemplary log-likelihood values over an entire test-shot can be accumulated and compared with exemplary values across C different GMM models (where C is the number of subjects).

### Other Exemplary Factors

Other factors that can be taken into consideration in certain exemplary embodiments of the present disclosure include, but are not limited to, e.g., the context of the video, the emotional state the speaker, the cultural background of the speaker, the size and/or characteristics of the target audience, the environmental conditions of the speaker and many other factors that can have an influence on a person's body-language.

Exemplary embodiments according to the present disclosure can also be used for many other tasks, such as, e.g., action recognition and general video classification (e.g., is the video showing a person, a car or another object with a typical motion statistics). Spatial information and other features in an exemplary video can also be utilized to, e.g., enhance face-detection in accordance with certain exemplary embodiments of the present disclosure. In addition to exemplary SVM classification in accordance with the present disclosure, unsupervised techniques and other supervised methods, such as Convolutional Networks and different incarnations of Dynamic Belief Networks can be applied to exemplary features in accordance with certain embodiments. Such exemplary networks can capture more long-range temporal features that are present in a signal.

Certain exemplary embodiments according to present disclosure can include programming computers, computing arrangements, processing arrangements, which can be un-supervised and/or acting without human intervention, to use exemplary systems and procedures in accordance with the present disclosure to, e.g., watch television and/or monitor all television channels continuously being operated and identify selected individuals based on their body signature, making increasingly fine distinctions among the videos and identified individuals, for example. Other exemplary applications of certain embodiments according to the present disclosure can include, e.g., using, e.g., MOS features and/or higher level statistics, determine a location of a person in a video as distinguished from, e.g., background clutter and/or animals, for example. In addition, certain exemplary embodiments of systems and/or procedures according to the present disclosure can be trained and/or train, e.g., exemplary systems and/or procedures to identify and/or determine, e.g., generic categories of a video, scene and/or shot, such as, e.g., a television commercial, a weather report, a music video, an audience reaction shot, a pan sequence, a zoom sequence, an action scene, a cartoon, a type of movie, etc.

Information and/or data acquired and/or generated in accordance with certain exemplary embodiments of the present disclosure can be stored on, e.g., a computer-readable medium and/or computer-accessible medium that can be part of, e.g., a computing arrangement and/or processing arrangement, which can include and/or be interfaced with computer-accessible medium having executable instructions thereon that can be executed by the computing arrangement and/or processing arrangement. These arrangements can include and/or be interfaced with a storage arrangement, which can be or include memory such as, e.g., RAM, ROM, cache, CD ROM, etc., a user-accessible and/or user-readable display, and user input devices, a communication module and other hardware components forming a system in accordance with the present disclosure, and/or analyze information and/or data associated with the device and/or a method of manufacturing and/or using the device, for example.

Certain exemplary embodiments in accordance with the present disclosure, including some of those described herein, can be used with the concepts described in, e.g., C. Bregler et al., Improving Acoustic Speaker Verification with Visual Body-Language Features, Proceedings of IEEE International Conference of Acoustics, Speech, and Signal Processing (ICASSP), 2009, and G. Williams et al., Body Signature Recognition, Technical Report: NYU TR-2008-915, 2009, the entirety of the disclosures of which are hereby incorporated by reference herein, and thus shall be considered as part of the present disclosure and application.

Additionally, embodiments of computer-accessible medium described herein can have stored thereon computer executable instructions for, e.g., analyzing video in accordance with the present disclosure. Such computer-accessible medium can be any available media that can be accessed by a general purpose or special purpose computer. By way of example, and not limitation, and as indicated to some extent herein above, such computer-accessible medium can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications link or connection (either hardwired, wireless, or a combination of hardwired or wireless) to a computer, the computer properly views the connection as a computer-accessible medium. Thus, any such a connection is properly termed a computer-accessible medium. Combinations of the above should also be included within the scope of computer-accessible medium.

Computer-executable instructions can include, for example, instructions and data which cause a general purpose computer, special purpose computer, or special purpose processing device or other devices (e.g., mobile phone, personal digital assistant, etc.) with embedded computational modules or the like configured to perform a certain function or group of functions.

Those having ordinary skill in the art will appreciate that embodiments according to the present disclosure can be practiced with network computing environments with many types of computer system configurations, including personal computers, hand-held devices, multi-processor systems, microprocessor-based or programmable electronics and devices, network PCs, minicomputers, mainframe computers, and the like. Embodiments in accordance with the present disclosure can also be practiced in distributed computing environments where tasks are performed by local and remote processing devices that are linked (either by, e.g., hardwired links, wireless links, or a combination of hardwired and wireless links) through a communications network. In a distributed computing environment, program modules can be located in both local and remote memory storage devices.

The foregoing merely illustrates the principles of the present disclosure. Various modifications and alterations to the described embodiments will be apparent to those having ordinary skill in the art in view of the teachings herein. It will thus be appreciated that those having ordinary skill in the art will be able to devise numerous devices, systems, arrangements, computer-accessible medium and methods which, although not explicitly shown or described herein, embody the principles of the present disclosure and are thus within the spirit and scope of the present disclosure. As one having ordinary skill in the art shall appreciate, the dimensions, sizes and other values described herein are examples of approximate dimensions, sizes and other values. Other dimensions, sizes and values, including the ranges thereof, are possible in accordance with the present disclosure.

It will further be appreciated by those having ordinary skill in the art that, in general, terms used herein, and especially in the appended claims, are generally intended as open. In addition, to the extent that the prior art knowledge has not been explicitly incorporated by reference herein above, it is explicitly being incorporated herein in its entirety. All publications referenced above are incorporated herein by reference in their entireties. In the event of a conflict between the teachings of the application and those of the incorporated documents, the teachings of the application shall control.

What is claimed is:

1. A computer-accessible medium containing executable instructions thereon, wherein when at least one computing arrangement executes the instructions, the at least one computing arrangement is configured to perform procedures comprising:
(i) receiving first information relating to one or more visual features from a video;
(ii) determining second information relating to motion vectors as a function of the first information; and
(iii) computing a statistical representation of a plurality of frames of the video based on the second information,
wherein the statistical representation includes at least in part a plurality of spatiotemporal measures of flow across the plurality of frames of the video.

2. The medium of claim 1, wherein the statistical representation includes at least in part a weighted angle histogram which is discretized into a predetermined number of angle bins.

3. The medium of claim 2, wherein each of the angle bins contains a normalized sum of flow magnitudes of the motion vectors.

4. The medium of claim 3, wherein the normalized sum of the flow magnitudes is provided in a particular direction.

5. The medium of claim 2, wherein the blurring is performed using a Gaussian kernel.

6. The medium of claim 1, wherein the values in each angle bin are at least one of blurred across angle bins or blurred across time.

7. The medium of claim 1, wherein one or more delta features are determined as temporal derivatives of angle bin values.

8. The medium of claim 1, wherein statistical representation is used to classify video clips.

9. The medium of claim 8, wherein the classification is only performed on clusters of similar motions.

10. The medium of claim 1, wherein the motion vectors are determined using at least one of optical flow, frame differences, and feature tracking.

11. The medium of claim 1, wherein the at least one computing arrangement is configured to at least one of (a) provide the statistical representation to a display device, or (b) record the statistical representation on a computer-accessible medium.

12. The medium of claim 1, wherein the statistical representation includes at least one of a Gaussian Mixture Model, a Support Vector Machine or higher moments.

13. A computer-accessible medium containing instructions which, when executed by at least one processing arrangement, configure the at least one processing arrangement to perform operations for analyzing a video comprising:
(i) receiving first information relating to one or more visual features from the video;
(ii) determining second information in each frame of the one or more visual features relating to motion vectors as a function of the first information;
(iii) determining a statistical representation for each video frame based on the second information;
(iv) determining a Gaussian mixture model over the statistical representation of all frames in the video in a training dataset; and
(v) obtaining one or more a super-features relating to the change of Gaussian mixture models in a specific video shot, relative to the Gaussian mixture model over the training dataset.

14. The medium of claim 13, wherein the at least one processing arrangement is configured to determine the motion vectors at locations where image gradients exceed a predetermined threshold in at least two directions.

15. The medium of claim 14, wherein the statistical representation is a histogram based on the angles of the motion vectors, and the histogram is weighted by a length of the motion vector, and normalized by a total sum of all motion vectors in one frame.

16. The medium of claim 15, wherein the at least one processing arrangement is configured to determine a delta between histograms.

17. The medium of claim 13, wherein the at least one processing arrangement is configured to locate clusters of similar motions using one or more super-features.

18. The medium of claim 17, wherein the at least one processing arrangement is configured to locate the clusters using at least one of a Bhattacharya distance or spectral clustering.

19. The medium of claim 13, wherein the at least one processing arrangement is configured to use the super-features for a classification with a discriminate classification technique including at least one Support-Vector-Machine.

20. The medium of claim 13, wherein the at least one processing arrangement is configured to use the super-features and at least one Support Vector Machine, and wherein the first information further relates to acoustic features.

21. The medium of claim 13, wherein the visual features are of at least one person in a video.

22. The medium of claim 21, wherein the visual features are of the at least one person while speaking.

23. The medium of claim 22, wherein the at least one processing arrangement is configured to use a face-detector, and compute the super-features of at least one of only around the face or body parts below the face.

24. The medium of claim 23, wherein the at least one processing arrangement is configured to apply a shot-detection procedure and to compute the super-features only inside a shot.

25. The medium of claim 13, wherein the at least one processing arrangement is configured to, using only MOS features, compute at least one of an L1 distance or an L2 distance to templates of other MOS features, wherein the at least one of the L1 distance or the L2 distance is computed with at least one of a standard sum of frame based distances or dynamic time warping.

26. A method for analyzing video, comprising:
(i) receiving first information relating to one or more visual features from a video;
(ii) determining second information relating to motion vectors as a function of the first information; and
(iii) computing a statistical representation of a plurality of frames of the video based on the second information;
wherein the statistical representation includes at least in part a plurality of spatiotemporal measures of flow across the plurality of frames of the video.

27. The method of claim 26, further comprising at least one of (a) providing the statistical representation to a display device, or (b) recording the statistical representation on a computer-accessible medium.

28. A method for analyzing video, comprising:
(i) receiving first information relating to one or more visual features from a video;
(ii) determining second information in each feature frame relating to motion vectors as a function of the first information;
(iii) computing a statistical representation for each video frame based on the second information;
(iv) computing a Gaussian mixture model over the statistical representation of all frames in a video in a training data-set; and
(v) computing one or more a super-features relating to the change of Gaussian mixture models in a specific video shot, relative to the Gaussian mixture model over the entire training data-set.
